(19) United States
(12) Patent Application Publication
(10) Pub. No.: US 2006/0285349 A1
(43) Pub. Date: Dec. 21, 2006

(54) Lamp base and lamp

(75) Inventors: Peter Helbig, Sontheim/Brenz (DE); Uwe Kantim, Heidenheim (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/438,372

(22) Filed: May 23, 2006

(30) Foreign Application Priority Data
May 24, 2005 (DE) 10 2005 024 435.1

(51) Int. Cl. F21V 7/04

(52) U.S. Cl. 362/549

(57) ABSTRACT

A lamp base has a plastic base part and a sprung metal ring, which is fixed to the plastic base part by webs integrally formed on the metal ring, the webs being designed such that there is a clamping fit between the webs and the plastic base part. The lamp base is preferably part of a vehicle headlamp.

### I. TECHNICAL FIELD

The invention relates to a lamp base having a plastic base part and a sprung metal ring, which is fixed to the plastic base part by means of webs integrally formed on the metal ring and to a lamp having such a base.

### II. PRIOR ART

Such a lamp base has been disclosed, for example, in WO 03/032365. This document describes a vehicle headlamp having a base, which has a plastic base part and a sprung metal ring fixed thereto. This metal ring has three integrally formed webs which are provided with barbs and provide an undetachable plugging connection between the metal ring and the plastic base part.

### III. SUMMARY OF THE INVENTION

One object of the invention is to provide a generic lamp base which allows for improved interaction between the plastic base part and the sprung metal ring fixed thereto.

This object is achieved according to the invention by a lamp base having a plastic base part and a sprung metal ring, which is fixed to the plastic base part by means of webs integrally formed on the metal ring, wherein the webs are designed such that there is a clamping fit between the webs and the plastic base part. Particularly advantageous embodiments of the invention are described in the dependent patent claims.

The lamp base according to the invention has a plastic base part and a sprung metal ring, which is fixed to the plastic base part by means of webs integrally formed on the metal ring, the webs being designed according to the invention such that there is a clamping fit between the webs and the plastic base part. This ensures that the metal ring is fixed mechanically in the plastic base part in a reliable manner without play.

In accordance with the preferred exemplary embodiment of the invention, the abovementioned webs cut into the material of the plastic base for the purpose of producing the clamping fit in order, as a result, to achieve simple and reliable anchoring of the metal ring in the plastic base part. As an alternative or in addition, the clamping fit between the webs of the metal ring and the plastic base part can be brought about or improved by the webs and/or the plastic base part being overdimensioned. When the metal ring and the plastic base part are joined together, the material of the plastic base part is thus compressed or pinched, and the two abovementioned base parts are fixed to one another without play.

The webs of the metal ring preferably interact with projections on a wall of the plastic base part for the purpose of producing the clamping fit. In accordance with the preferred exemplary embodiment of the invention, the webs cut into the plastic material of these projections in order to achieve play-free and secure anchoring of the metal ring in the plastic base part. As an alternative or in addition, the clamping fit between the webs of the metal ring and the projections on the wall of the plastic base part can be brought about or improved by the abovementioned webs and/or projections being overdimensioned. When the metal ring and the plastic base part are joined together, part of the plastic material of the projections is compressed or pinched by means of the webs of the metal ring and, as a result, the two abovementioned base parts are fixed to one another without play by means of the webs and projections.

The webs of the metal ring are preferably provided with sharp-edged sections in order to make it possible for them to easily penetrate the plastic material of the plastic base part.

The sharp-edged sections of the webs are preferably designed to be bent back or in the form of hooks or in the form of claws in order to make it possible for them to be securely anchored in the projections on the wall of the plastic base part.

In accordance with the preferred exemplary embodiment of the invention, the projections on the wall of the plastic base part are each arranged between two webs of the metal ring, with the result that the sharp-edged sections of these webs each cut into the projection arranged between them and hook in or dig in there. The distance between the sharp-edged sections of these webs is less than the width of the projection arranged between them.

Alternatively, the webs of the metal ring can also each be arranged between two projections on the wall of the plastic base part, with the result that the sharp edges of the respective web cut into projections arranged on both sides of this web, and the webs hook in or dig in there. In this case, the width of the sharp-edged web section is preferably greater than the distance between the projections, which are arranged on both sides of this web, on the wall of the plastic base part. For this purpose, the webs of the metal ring may have, for example, the shape of an arrow tip provided with barbs.

As a further alternative, a web of the metal ring may be arranged on a projection on the wall of the plastic base part, with the result that one or more sharp edges on one side of the web cut into or become stuck in the projections on the base; for this purpose, at least one further web with the sharp edge on the other side is required in order to cause it to become stuck in said projections.

However, in the abovementioned alternatives, the clamping fit can also be achieved without any sharp-edged sections of the webs, merely by means of an overdimensioning tolerance between the projection and the web. For example, in each case one projection of the plastic base part can be arranged between two webs of the metal ring, the clamping fit being achieved by the distance between the two webs being slightly smaller than the width of the projection.

The webs integrally formed on the metal ring advantageously extend perpendicularly to its ring surface in order for it to be possible for its position with respect to the plastic base part to be fixed by means of the webs.

In accordance with the preferred exemplary embodiment of the invention, the metal ring has spring elements which act perpendicularly to its ring surface, and the ring surface of the metal ring rests on a surface of the plastic base part, the surface of the plastic base part having depressions in the region of the spring elements. These depressions provide more space for the abovementioned spring elements to unfold their spring effect perpendicularly to the ring plane.

The invention is preferably envisaged for metal/plastic bases of incandescent lamps for vehicles, but can also be applied to bases of other lamp types.

### IV. BRIEF DESCRIPTION OF THE DRAWINGS

The invention will be explained in more detail below with reference to a preferred exemplary embodiment. In the drawing:

FIG. 1 shows a plastic base part of a lamp base having a sprung metal ring fixed thereto in accordance with the preferred exemplary embodiment of the invention,

FIG. 2 shows the plastic base part shown in FIG. 1 without the sprung metal ring,

FIG. 3 shows the sprung metal ring shown in FIG. 1 without the plastic base part,

FIG. 4 shows an enlarged illustration of the webs of the metal ring depicted in FIG. 3, and

FIG. 5 shows a vehicle lamp having the plastic base part and metal ring depicted in FIG. 1.

### V. BEST MODE FOR CARRYING OUT THE INVENTION

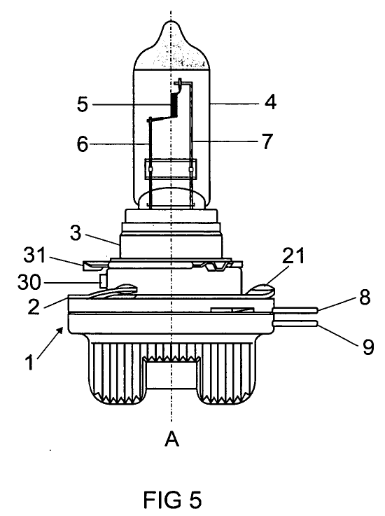

The lamp according to the invention depicted in FIG. 5 is a halogen incandescent lamp, which is envisaged for use in a motor vehicle headlight. This lamp has a vitreous, essentially cylindrical lamp vessel 4 having an incandescent filament 5 enclosed therein, whose filament axis is arranged such that it is offset parallel to the longitudinal axis A of the lamp or to the cylinder axis of the lamp vessel 4. Two power supply lines 6, 7, which are passed out of that end of the lamp vessel 4 which is near to the base, are used for holding and supplying voltage to the incandescent filaments 5. That end of the lamp vessel 4 which is near to the base is anchored with a clamping fit in a cutout in a metallic lamp base part 3. The other end of the vitreous lamp vessel 4 is provided with an opaque coating. The metallic lamp base part 3 and a sprung metal ring 2 are each fixed on a plastic base part 1. Two electrical connections, in the form of metallic contact lugs 8, 9, of the vehicle lamp protrude laterally out of the plastic base part 1 and are each electrically conductively connected to one of the power supply lines 6, 7. The metallic lamp base part 3 is equipped with three reference tabs 31, which extend in a plane perpendicular to the longitudinal axis A of the lamp and interact with three spring elements 21, 22, 23 for the purpose of mounting the lamp in the holder of a vehicle headlight. The three spring elements 21, 22, 23 unfold a spring action in the direction of the longitudinal axis A of the lamp, with the result that the holder or lampholder of the vehicle headlight is arranged with a clamping fit between the reference tabs 31 and the spring elements 21, 22, 23 once the lamp has been mounted, it being ensured that the incandescent filament 4 is aligned with respect to the optical axis of the headlight owing to the design and arrangement of the three reference tabs 31 in interaction with the abovementioned holder. The metallic lamp base part 3 is also provided with a lateral contact-pressure spring 30, which unfolds a spring action perpendicular to the longitudinal axis A and thus ensures that the lamp is fixed laterally in the holder.

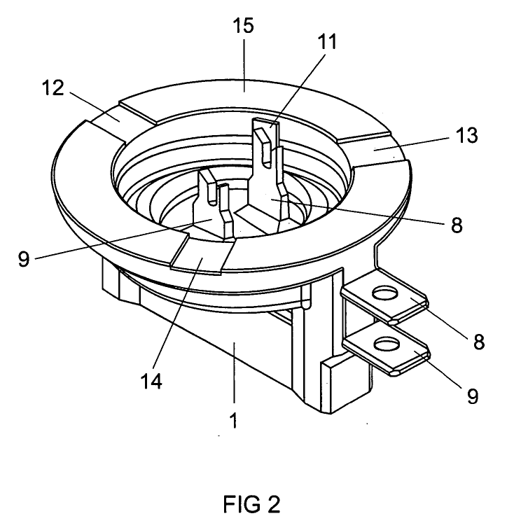

FIG. 2 illustrates the plastic base part 1 of the vehicle lamp depicted in FIG. 5. The electrical connections 8, 9 are embedded in the plastic base part 1 and are in the form of metallic contact lugs, those ends of said electrical connections 8, 9 which protrude into the base each being welded to one of the power supply lines 6 and 7, respectively. The contact faces, protruding out of the base, of the contact lugs 8, 9 are each provided with an aperture in the form of a circular disk. The plastic base part 1 is essentially in the form of a pot and has an annular bearing face 15 for the metal ring 2, said bearing face 15 being interrupted by three depressions 12, 13, 14 in the region of the spring elements 21, 22, 23 of the metal ring 2. The inner wall of the plastic base part 1 is equipped with three web-shaped projections 11, which are arranged equidistantly and are used for fixing the metal ring 2.

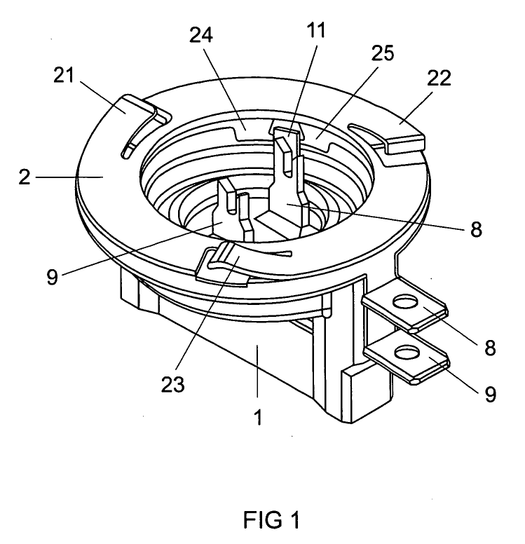

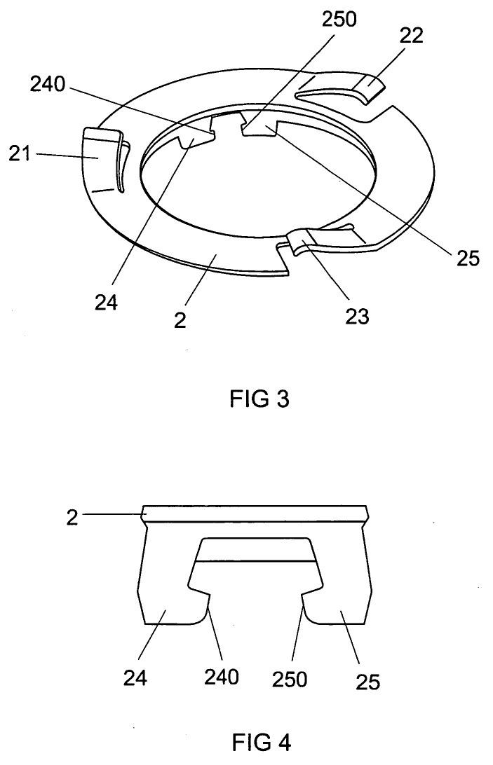

FIG. 3 illustrates the sprung metal ring 2. The metal ring 2 has three spring elements 21, 22, 23, which are arranged equidistantly along its outer ring circumference, whose free ends protrude out of the ring plane, and which unfold a spring action perpendicular to the ring plane or ring surface. In addition, the metal ring 2 has three pairs of webs 24, 25, which extend perpendicularly to the ring plane or ring surface, are arranged equidistantly along the inner ring circumference and are integrally formed on the metal ring 2. The end sections 240 and 250 of the metal webs 24 and 25, respectively, are sharp-edged and in the form of hooks. FIG. 4 shows an enlarged detail of the metal ring 2 shown in FIG. 3 and, in particular, details of the webs 24, 25. The end sections 240, 250 of the webs 24, 25 interact with a projection 11 in order to fix the metal ring 2 to the plastic base part 1. In each case one projection 11 is arranged with a clamping fit between each pair of webs 24, 25. The distance between the sharp-edged, hook-shaped end sections 240, 250 of a web pair 24, 25 is less than the width of the corresponding projection 11, with the result that the sharp-edged, hook-shaped end sections 240, 250 cut into the plastic material of the projection 11 when the metal ring 2 is mounted on the plastic base part 1 and hook in there. FIG. 1 is a schematic illustration of the plastic base part 1 with the metal ring 2 mounted thereon and of the interaction between the metal webs 24, 25 and a projection 11 on the inner wall of the plastic base part 1. The three pairs of metal webs 24, 25 bear against the inner wall of the plastic base part 1.

The invention is not restricted to the exemplary embodiment explained in more detail above. For example, the metal ring 2 may also only have one pair of webs 24, 25 or have more than three pairs of webs 24, 25. In addition, the webs 24, 25 do not necessarily need to bear against the inner wall of the plastic base part 1 or be arranged equidistantly. In addition, the invention can also be applied to any other desired lamps which have a metal/plastic base.

1. A lamp base having a plastic base part and a sprung metal ring, which is fixed to the plastic base part by means of webs integrally formed on the metal ring, wherein said webs are designed such that there is a clamping fit between the webs and said plastic base part.

2. The lamp base as claimed in claim 1, wherein the webs cut into the material of the plastic base part for the purpose of producing the clamping fit.

3. The lamp base as claimed in claim 1, wherein the clamping fit between the webs and the plastic base part (1) is brought about by the webs and/or the plastic base part being overdimensioned.

4. The lamp base as claimed in claim 1, wherein the webs interact with projections on a wall of the plastic base part for the purpose of producing the clamping fit.

5. The lamp base as claimed in claim 4, wherein the webs cut into the material of the projections.

6. The lamp base as claimed in claim 4, wherein the clamping fit between the webs and the projections is brought about by the webs and/or the projections being overdimensioned.

7. The lamp base as claimed in claim 1, wherein the webs have sharp-edged sections.

8. The lamp base as claimed in claim 1, wherein the webs extend perpendicularly to the ring surface of the metal ring.

9. The lamp base as claimed in claim 7, wherein the sharp-edged sections are designed to be bent back or in the form of hooks or in the form of claws.

10. A lamp having a lamp base as claimed in claim 1.
